(19) United States
(12) Patent Application Publication
(10) Pub. No.: US 2015/0052676 A1
(43) Pub. Date: Feb. 26, 2015

(54) WASH BASIN WITH FOOT WASHING FACILITY

(71) Applicant: Moin Uzzaman AZMI, (US)

(72) Inventor: Moin Uzzaman Azmi, Manchester (GB)

(21) Appl. No.: 14/383,937

(22) PCT Filed: Mar. 11, 2013
(86) PCT No.: PCT/GB2013/050597

§ 371 Date: Sep. 9, 2014

(30) Foreign Application Priority Data
Mar. 12, 2012 (GB) 1204341.0

(51) Int. Cl. E03C 1/01; A61H 33/00; E03C 1/14

(52) U.S. Cl. CPC E03C 1/01; E03C 1/14; A61H 33/6021; A61H 2203/0406
USPC 4/622

(57) ABSTRACT

A pedestal wash basin (1) comprising a basin part (3) upon a pedestal part (2) wherein the pedestal part contains a foot washing apparatus (4) for washing a human foot comprising a washing chamber with walls and a ceiling defining a covered hollow (6) dimensioned and arranged for receiving a foot of a user via an inlet opening (5) in a wall positioned for admitting the foot into the hollow. A water outlet (7, 8) is attached to the washing chamber at a position from which to output water across the hollow of the washing chamber in a direction to intersect the foot of the user when so admitted via the inlet opening. The pedestal part presents a through-opening (3B) in an outwardly-presented surface thereof in register with the hollow of the washing chamber permitting access to the hollow for washing the foot of a user.

### TECHNICAL FIELD

The present invention relates to washing facilities for washing the parts of the human body, and particularly though not exclusively, to washing the human foot whilst the user is in a standing position.

### TECHNICAL BACKGROUND

According to Muslim practice, the ritual washing of the face, hands, arms and feet is preferably conducted before praying. While the washing of the face, arms and hands may be performed using a typical washing basin, with relatively little discomfort, the washing of the feet can be far less convenient. It is very difficult to wash feet within a wash basin since they are usually positioned at about waist height and are not intended for use in washing feet. Indeed, for the elderly or infirm, it may be impossible to wash ones feet in such a basin.

As a result of this, separate washing facilities are usually required to permit the washing of feet. This can include provision of a simple washing bowl located at floor lever, or the use of a bath tub. Neither may be available and each requires additional space in a wash room in which space is at a premium.

The invention aims to address these matters.

### DISCLOSURE OF THE INVENTION

In a first of its aspects, the invention provides a foot washing apparatus for washing a human foot comprising a washing chamber defining a hollow (e.g. a covered hollow) dimensioned and arranged for receiving the foot of a user (e.g. through an opening therein), a first water outlet attached to the washing chamber at a first position from which to output water in a first direction across the hollow of the washing chamber, and a second water outlet attached to the washing chamber at a second position from which to output water in a second direction across the hollow of the washing chamber, wherein the first position and the second position are spaced and arranged so as to admit the foot of a user between the first water outlet and the second water outlet such that the first direction and the second direction simultaneously intersect the foot so admitted.

In this way, an efficient and compact foot washing apparatus may be provided.

The dimensions of the chamber are preferably such as to admit a single foot of a user (e.g. an adult male) preferably fully from heal to toe. The width of the chamber may be between 20 cm and 40 cm (e.g. about 30 cm). The depth of the chamber may be between about 30 cm and about 45 cm (e.g. about 40 cm).

The first water outlet and the second water outlet may be positioned respectively at substantially opposite parts of the washing chamber within the hollow thereof. The first direction may be substantially opposite to the second direction.

The first direction may be oblique to the second direction. Preferably, the first direction and the second direction are generally convergent.

One or more of the first water outlet and the second water outlet may comprise a plurality of sub-outlets adapted and arranged in an array to output water therefrom as a shower of water. The first water outlet and the second water outlet may be positioned respectively at substantially opposite walls of the washing chamber within the hollow thereof to permit the foot of a user to be washed thereby from opposite sides.

Alternatively, the first water outlet and may be positioned at the floor of the washing chamber within the hollow thereof and the second water outlet may be positioned at the ceiling of the washing chamber within the hollow thereof to permit the foot of a user to be washed thereby from above and below.

The washing chamber preferably comprises an inlet opening permitting access to the hollow and dimensioned to admit the foot of a user. In preferred embodiments at least a part of the floor of the washing chamber is inclined towards the inlet opening and at least a part of the ceiling of the washing chamber is inclined towards the inclined parts of the floor.

The foot washing apparatus may include a third water outlet attached to the washing chamber at a third position to output water in a third direction across the hollow of the washing chamber. The first position, the second position and the third position may be spaced and arranged so as to admit the foot of a user between the third water outlet and the first water outlet and/or the second water outlet such that the first direction and the second direction and/or the second direction simultaneously intersect the foot so admitted.

The foot washing apparatus may include a third water outlet attached to the washing chamber at a third position to output water in a third direction across the hollow of the washing chamber, and a fourth water outlet attached to the washing chamber at a fourth position to output water in a fourth direction across the hollow of the washing chamber. The third position and the fourth position are preferably spaced and arranged so as to admit the foot of a user between the third water outlet and the fourth water outlet such that the third direction and the fourth direction simultaneously intersect the foot so admitted.

The first water outlet and the second water outlet may be positioned respectively at substantially opposite walls of the washing chamber within the hollow thereof to permit the foot of a user to be washed thereby from opposite sides.

The third water outlet and may be positioned at the floor of the washing chamber within the hollow thereof and the fourth water outlet may be positioned at the ceiling of the washing chamber within the hollow thereof to permit the foot of a user to be washed thereby from above and below.

The foot washing apparatus may include one or more water conduits for receiving water from a water supply independent of the apparatus (e.g. mains water) and for conducting the received water to the water outlets thereof.

In a second aspect, the invention may provide afoot washing apparatus for washing a human foot comprising a washing chamber with walls and a ceiling defining a covered hollow dimensioned and arranged for receiving a foot of a user via an inlet opening in a said wall positioned for admitting the foot into the hollow, a water outlet attached to the washing chamber at a position from which to output water across the hollow of the washing chamber in a direction to intersect the foot of the user when so admitted via said inlet opening. The water outlet may be attached to the ceiling of the washing chamber, or to a wall or to the floor thereof. The water outlet may be attached to a wall, ceiling or floor of the washing chamber via a support part which extends in a direction across/into the chamber to locate the water outlet further within the hollow of the chamber, e,g. centrally. The water outlet may be arranged to output water in any desired direction(s).

The ceiling is preferably inclined relative to said wall containing said inlet opening so as to face in a direction away from the inlet opening. The ceiling and walls of the washing chamber may converge so as to meet to form a substantially continuous covering surface in the hollow.

The washing chamber may comprise opposing said walls spaced by a spacing suitable to admit the width of a foot of the user. The walls may extend from either side of the inlet opening to meet a back wall positioned opposite the inlet opening. The walls may be spaced therefrom by a spacing suitable to admit the length of a foot of a user.

The foot washing apparatus may comprise a base surface from the edges of which said walls rise to meet said ceiling, wherein the walls surround the base surface on at least three sides and the base surface is adapted to receive water output by the water outlet.

The base surface and walls of the washing chamber may converge so as to meet to form a substantially continuous boundary in the hollow.

The invention may comprise an apparatus according to both the first and second aspects described above.

In a third of its aspects, the invention may provide a pedestal wash basin comprising a basin part upon a pedestal part wherein the pedestal part contains the foot washing apparatus described above, and presents a through-opening in an outwardly-presented surface thereof in register with the hollow of the washing chamber permitting access to the hollow for washing the foot of a user. The peripheral edges of the through-opening may be in register with peripheral edges of an access opening of the foot washing apparatus which permits foot-access to the hollow. This permits precise registration and accurate positioning of the foot within the hollow when passed through the through-opening. The access opening and the through-opening may be substantially the same shape, and may be substantially the same size/dimension. The outwardly presented surface of the pedestal part may be substantially vertical, or generally upright, such that the through-opening is substantially vertical or generally upright (e.g. slightly inclined to the vertical, such as by less than 5 degrees). The access opening may be correspondingly substantially vertical or generally upright. The Advantages of the positioning the hollow in register with the through-opening of the pedestal part include ease of access by a user. In another aspect the invention may provide a sink or wash basin to which is adjoined said foot washing apparatus as described above. The foot washing apparatus may include attachment means (e.g. straps, clips, grips of bolts etc) with which to attach to a sink, basin or pedestal thereof, in a manner such as would be apparent to the skilled person. The washing apparatus need not be adapted to be housed/housable within a pedestal and may be otherwise adjoined to a sink by means readily available to the skilled person.

The foot washing apparatus is preferably detachably attached to the pedestal part.

In a fourth of its aspects, the invention provides a kit of parts for a pedestal wash basin comprising, a pedestal part, a basin part adapted to be mounted upon the pedestal part, and the foot washing apparatus described above, wherein the pedestal presents a through-opening in an outwardly-presented surface thereof and the foot washing apparatus is adapted to be mounted within the pedestal part to place said through-opening in register with said hollow of said washing chamber to permit access to said hollow for washing the foot of a user.

### DESCRIPTION OF THE DRAWINGS

To better illustrate the invention there now follows a non-limiting example of an embodiment of the invention with reference to the accompanying drawings of which:

FIG. 1 illustrates an exploded view of a pedestal wash basin comprising a detachable foot washing unit according to an embodiment of the invention;

FIG. 2 illustrates a back view of the pedestal wash basin of FIG. 1 in assembled form;

FIGS. 3a, 3b and 3c illustrate the pedestal wash basin of FIG. 1 in use;

FIG. 4 illustrates a perspective view of the pedestal wash basin of FIG. 1 in assembled form;

FIG. 5 illustrates a top view of the pedestal wash basin of FIG. 1 in assembled form;

FIG. 6 illustrates a side view of the pedestal wash basin of FIG. 1 in assembled form;

FIG. 7a illustrates schematically a diagram of suitable plumbing for the pedestal wash basin of FIG. 1;

FIG. 7b illustrates schematically a diagram of another suitable plumbing for the pedestal wash basin of FIG. 1;

FIGS. 8a to 8f schematically show alternative positions and arrangements of any pair of water outlets of the invention in alternative embodiments, while FIGS. 8g, 8h and 8i show different positioning of a single water outlet;

FIG. 9 illustrates a pedestal basin with detached pedestal front pane;

FIG. 10 illustrates a pedestal basin with detached pedestal side panels;

FIG. 11 shows a rear view of a pedestal basin;

FIG. 12 shows an exploded view of a pedestal basin.

In the drawings, like items are assigned like reference symbols.

### DETAILED DESCRIPTION

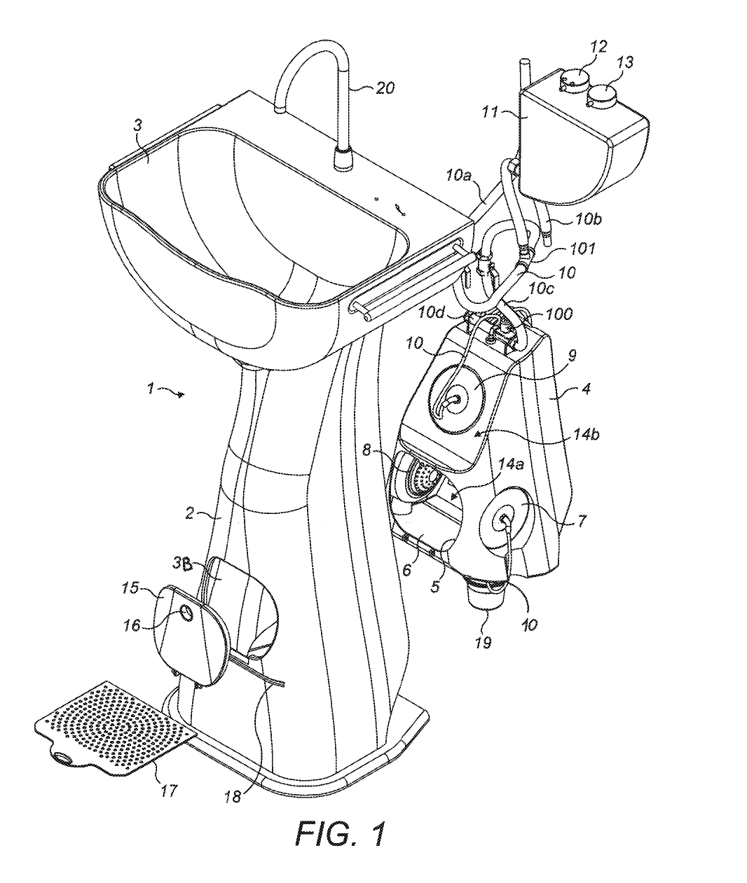

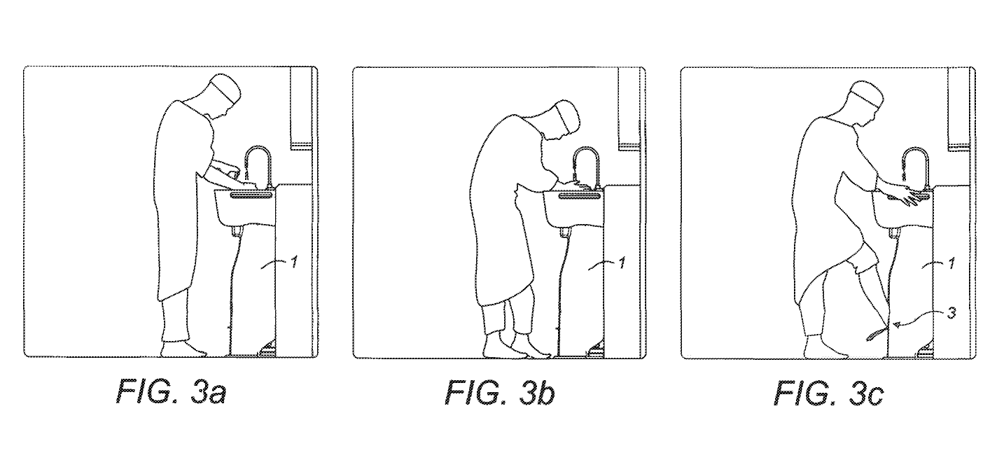

FIG. 1 shows a pedestal wash basin (1) comprising a wash basin part (3) mounted atop a pedestal part (2). The pedestal part comprises a hollow columnar body with a through-opening (3B) formed in the vertical forward-facing surface thereof positioned so as to directly face a person when stood in front of the wash basin part in normal use. The through-opening is formed at about mid-shin height relative to a typical adult user and is dimensioned to admit comfortably the foot of the user as shown in FIG. 3c. A door (15) is pivotingly attached to the pedestal part at the lower peripheral edge of the through-opening to permit the through-opening to be selectively covered and uncovered by the door. A finger hole (16) is formed within the door and passes through the surface parts of the door which, when closed, are positioned adjacent the uppermost edge of the through-opening.

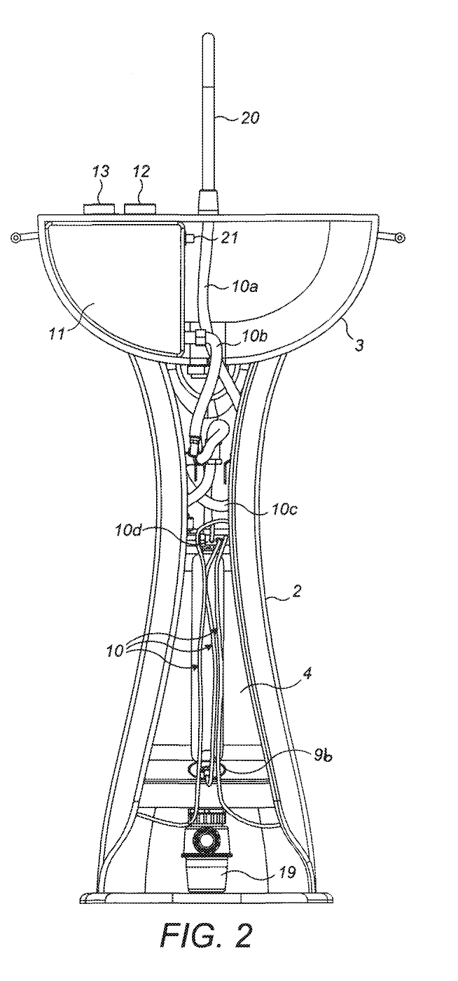

The pedestal part is open at its rear, as shown in FIG. 2, this being the region of the pedestal part intended to face or abut a wall of a bathroom or the like so as not to be outwardly presented in use.

A foot washing unit (4) is adapted and arranged to be mounted within the hollow columnar body of the pedestal part via as illustrated in FIG. 2.

The foot washing unit comprises a washing chamber defining a hollow (6) adapted and arranged to admit comfortably the foot of the user via an access opening (5) formed in a wall of the washing chamber.

The access opening is positioned in register with the through-opening formed in the wall of the pedestal part when the foot washing unit is mounted within the hollow of the pedestal part as shown in FIG. 2. The peripheral edges of the through-opening are in register with peripheral edges of an access opening of the foot washing apparatus which permits foot-access to the hollow. The access opening and the through-opening are substantially the same shape and size/dimension. The outwardly presented surface of the pedestal part is generally upright such that the through-opening is generally upright, and the access opening is correspondingly generally upright.

A first water outlet (7) is attached to the washing chamber at a first position at a side wall of the washing chamber and is arranged to output water in a first direction substantially horizontally across the hollow of the washing chamber. A second water outlet (8) is attached to the washing chamber at a second position on a second side wall of the washing chamber substantially opposing the first side wall and is arranged to output water in a second direction substantially horizontally across the hollow of the washing chamber. The second direction is generally opposite to the first direction so that water output by the first water outlet is directed across the hollow of the washing chamber towards the second water outlet, and vice versa. The first and second water outlets are thereby spaced so as to admit the foot of a user between them. In this way, the water output in the first direction and the second direction simultaneously intersect the foot so admitted. In addition to the two walls containing the first and second water outlets, the washing chamber comprises a floor and a ceiling. At least a part of the floor (14a) of the washing chamber is inclined towards the inlet opening (5) of the washing chamber, and at least a part of the ceiling (14b) is inclined towards the inclined parts of the floor so that the former faces the latter.

A third water outlet (9) is attached to the washing chamber at a third position at the inclined ceiling of the washing chamber and is arranged to output water in a third direction across the hollow of the washing chamber in an inclined or oblique, downward direction. A fourth water outlet (9b, FIG. 2) is also attached to the washing chamber at a fourth position at the inclined floor (14a) of the washing chamber to output water in a fourth direction across the hollow of the washing chamber in an oblique in an inclined or oblique upward direction. The third and fourth water outlets are thereby spaced and arranged so as to admit the foot of a user between them. The third direction is generally opposite to the third direction so that water output by the third water outlet is directed across the hollow of the washing chamber towards the fourth water outlet, and vice versa. The third and fourth water outlets are thereby spaced so as to admit the foot of a user between them. In this way, the water output in the third direction and the fourth direction simultaneously intersect the foot so admitted. It will be appreciated that, due to this arrangement four water outlets within the washing chamber, the first and second water outlets positioned respectively at substantially opposite walls of the washing chamber permit the foot of a user to be washed thereby from opposite sides while, concurrently, the third water outlet at the inclined floor of the washing chamber permits the sole of the foot to be washed while the fourth water outlet at the ceiling of the washing chamber permits the top of the foot of a user to be washed. Thus, concurrent washing by water at opposite sides of the foot and from above and below is permitted.

The inclination of the floor and ceiling parts allows the third and fourth water outlets to be attached thereto in an inclined orientation to match the generally inclined orientation of the sole and upper surface of an inserted foot and thereby better target those surface with water.

It will be appreciated that the floor surface and ceiling surface of the foot washing chamber may be substantially horizontal in other embodiments, and the third and fourth directions substantially vertical, or the third and fourth water outlets arranged to output water obliquely from so that the third and fourth directions are oblique as described above. However, inclining the floor and ceiling surfaces reduces the volume of the hollow of the foot washing and the overall size of the foot washing unit.

The four water outlets each comprise diffuser heads which output water in the form of a shower spray or jet. Other types of water outlet may be used.

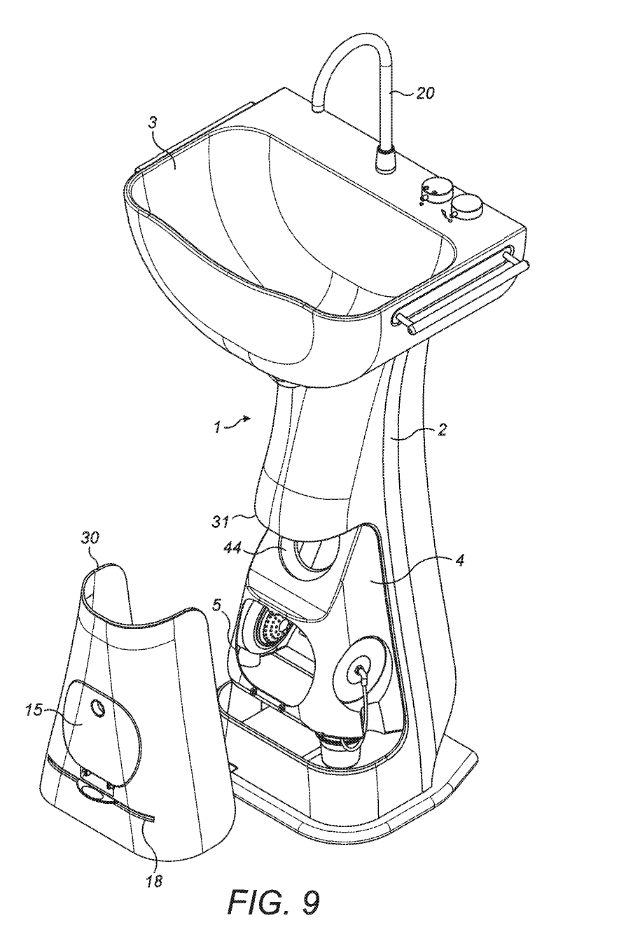

Circular holes (44, FIGS. 9, 10 and 12) are formed within the walls, inclined floor and ceiling of the washing chamber for removeably receiving each circular a shower head as a unit.

The foot washing apparatus includes water conduits (10) for receiving water from a water supply independent of the apparatus (e.g. mains water) and for conducting the received water to each of the four water outlets. A control unit (11) comprises manually operable dial controls (12, 13). A first dial control (13) is operable by the user to control the rate of flow of water and a second dial control (12) is operable to control the temperature of the water, this being achieved by d heating cold water input through dedicated cold water input opening (one of the two shown as 21, FIG. 2) provided in the control unit. Heating of and the supplied cold water, controlled via the second control dial, is performed by suitable water heating apparatus (not shown) within the control unit prior to conducting the mixed water to the water outlets. Methods and apparatus such as would be readily apparent to the skilled person may be employed to implement these controls and mixing. Heated water is conducted from the control unit via a first portion of water conduit (10b) to a valve which bifurcates the water conduit in to a second conduit part (10a) for delivering water to a tap (20) of located at the basin part (3). A second part (10c) of the bifurcated water conduit conducts water to a second valve (10d) which separates the water into four concurrent conduits each one of which is dedicated to a respective one of the four water outlets (7, 8, 9, 9a) of the washing chamber. A waste water outlet (19) is in fluid communication with the hollow of the washing chamber for receiving waste water therefrom. It will be appreciated that the water conduit permits water of the same temperature (heated water) to be conducted to both the basin tap (20) and the foot washing unit (4) such that water output there has the same temperature.

A grille (17) is provided for resting the foot of the user upon during a washing operation. An array of holes in the grille permit water to pass through the grille in use. A handle is formed on the edge of the grille outermost in use for allowing a user to extract the grille from the mashing unit (4) and from the pedestal (2) for cleaning. A grille slot (18) is formed in the front surface of the pedestal for this purpose. The washing unit also has a second grille slot (not shown) of the same shape and dimensions as the grille slot in the pedestal. This second grille slot is positioned in the outer surface of the washing unit below the access opening (5) of the washing unit and is in communication with the hollow (6) of the washing unit. The second grille slot is positionable in register with the grille slot in the pedestal such that the grille may be retractably inserted into the hollow (6) of the washing unit by the user.

Sensor(s) (not shown) are located within the hollow of the foot washing unit and is/are arranged to detect the presence of a foot within the hollow. Position sensors and/or movement sensors such as would be readily apparent to the skilled person may be used for this purpose. The sensors are arranged to control the operation of the second valve (10d) via a valve control unit (100) to control the flow of water supplied to each of the four water outlets at the top of the washing unit. Detection of a foot within the hollow via the sensor(s) causes the valve control unit (100) to open the second valve (10d) and permit the water supplied (10c) to the foot washer to pass to the four water outlets. The absence of a foot causes the sensor(s) to detect this fact and to cause the valve control unit (100) to close the second valve (10d) and prevent further outputting of water from the water outlets.

FIG. 2 shows a rear view of the pedestal sink with the foot washing unit mounted within the inner space of the pedestal.

FIGS. 3a, 3b and 3c show schematically how the pedestal basin may be used. A user may wash his/her arms (FIG. 3a) and hands (FIG. 3b) in the basin part (3) of the pedestal basin employing the tap (20) dedicated to the basin. In addition, the user may insert a foot through the through-opening of the pedestal part and into the hollow of the foot washing chamber (FIG. 3c) to position the foot there between the first to fourth water outlets where the foot may be washed. Handles (21) are attached to either side of the basin part (3) to allow the user to steady themselves whilst one foot is being washed in this way.

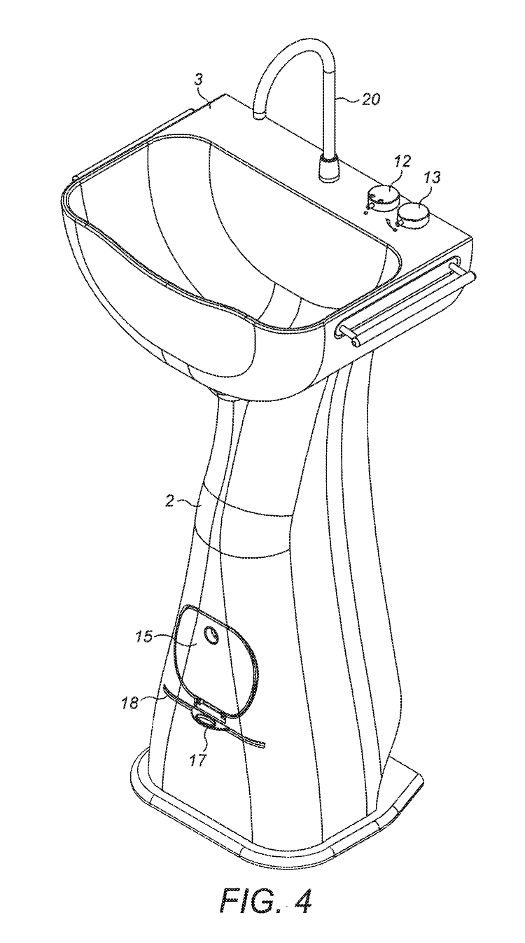

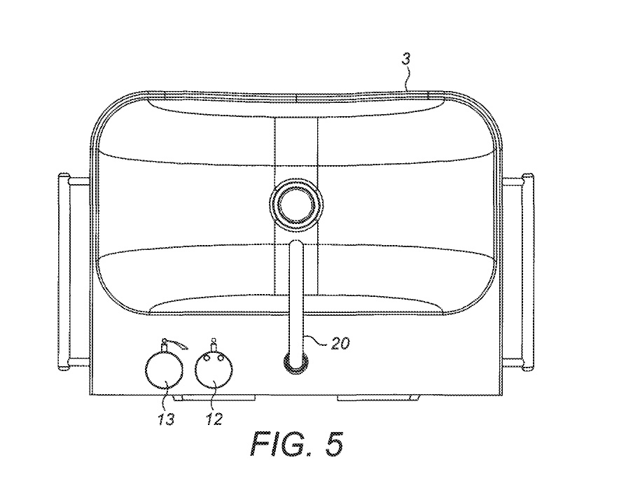

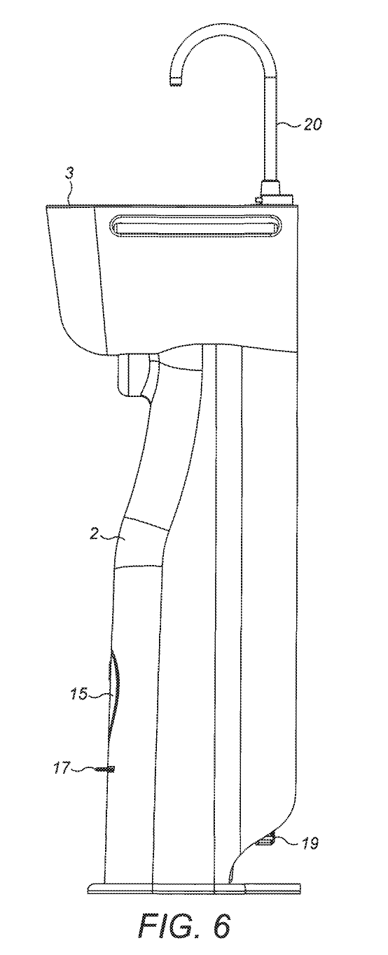

FIGS. 4, 5 and 6 show, respectively, a perspective view, a top view and a side view of the pedestal wash basin of FIGS. 1 and 2, in assembled form with the foot washing unit mounted.

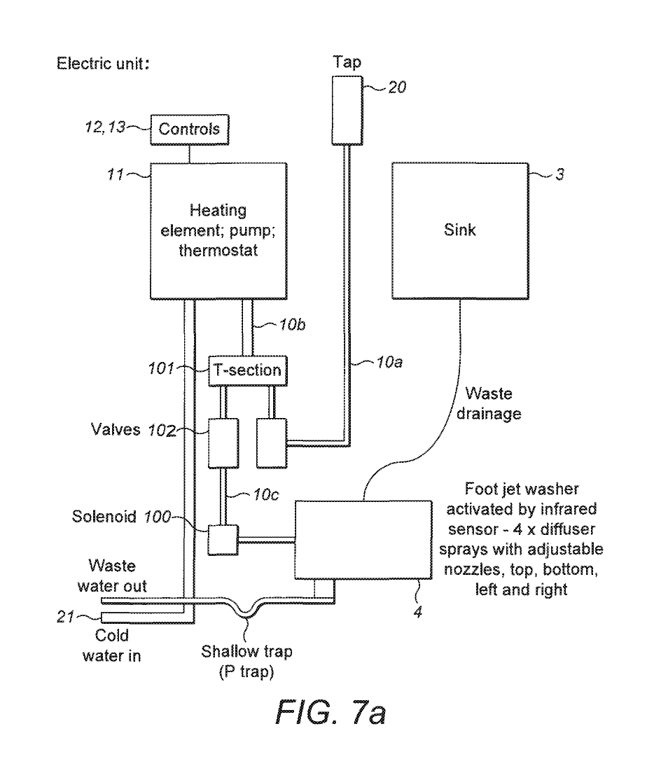

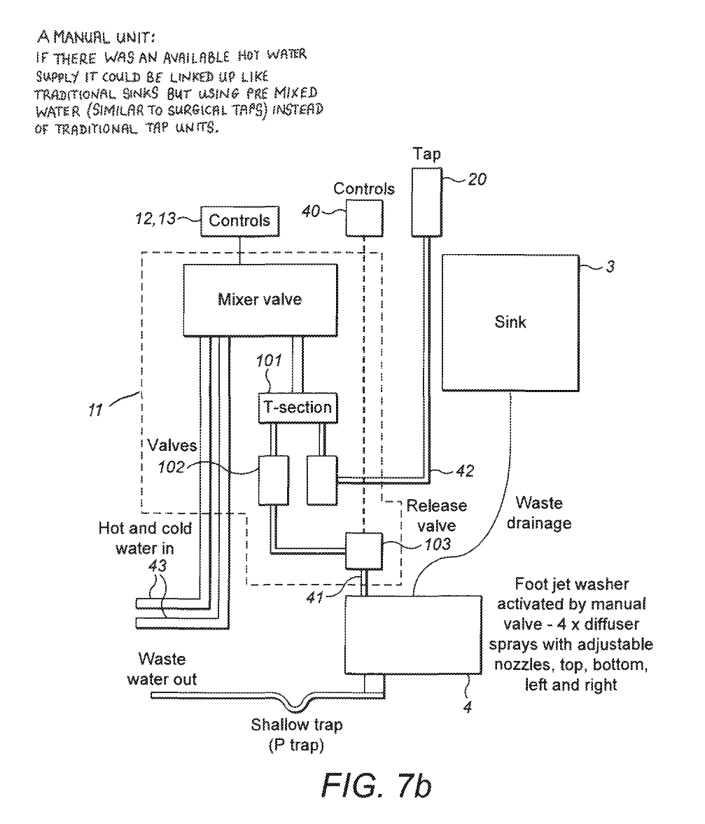

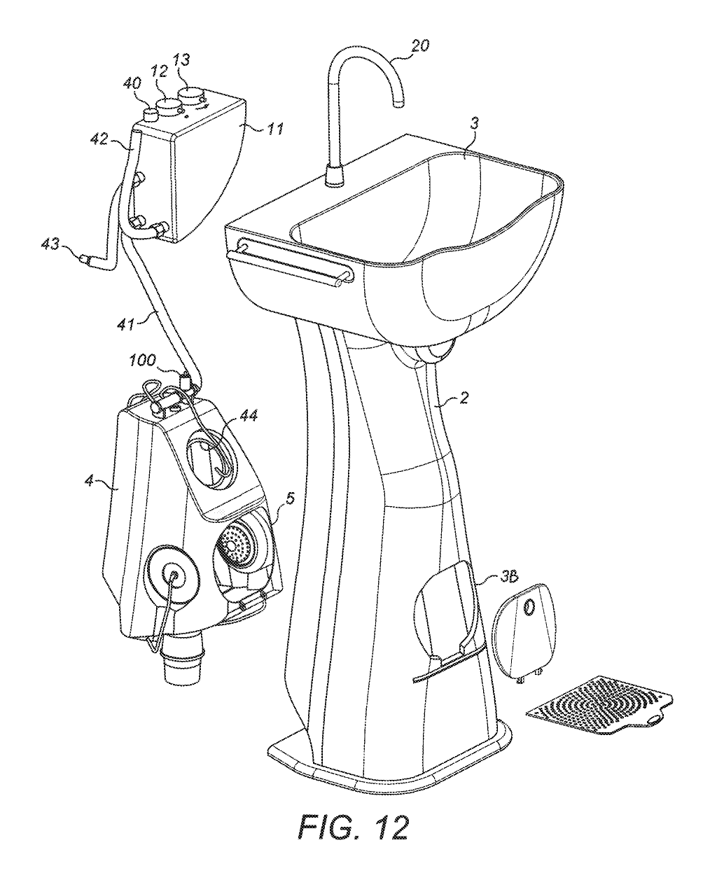

FIGS. 7A and 7B schematically illustrate a diagram of suitable plumbing for the pedestal wash basin of FIG. 1 and an alternative form of the apparatus of FIG. 12. FIG. 7A illustrates plumbing and controls applicable to the embodiment illustrated in FIG. 1 (Electric Unit) in which infrared sensors are employed to detect the presence/absence of a foot within the hollow of the washing unit.

In particular, FIG. 7A schematically illustrates the plumbing and controls of the apparatus of FIG. 1. Water pressure and temperature controls (12, 13) are operably connected to the control unit (11) which contains a thermostatically regulated heating element (not shown) for heating the water supplied (21) to the control unit according to the user's operation of the temperature control dial (12). A water pump (not shown) is also contained within the control unit for generating the water pressure desired by the user according to the user's operation of the water pressure control dial (13).

The control unit is adapted to supply heated water via an outlet conduit (10b) to a T-section valve (101) where the water conduit is bifurcated and supplied to the basin tap (20) and the foot wash chamber (4) simultaneously. Intermediate manual valves (102) allow either water conduit to be closed/opened manually as desired. A solenoid valve (100) is responsive to infra-red sensors (not shown) adapted to detect the presence of e.g. a foot within the washing chamber and to control the solenoid valve to open the water conduit (10c) to allow the heated water to flow to the water outlets within the washing chamber when such detection is made, and to close the solenoid valve otherwise.

FIG. 7B shows an alternative arrangement in which hot and cold water are input to the control unit (11) which does not contain a heating element of FIG. 7A but, instead, contains a mixer valve which mixes the received hot and cold water in the proportion desired by the user according to the user's operation of the temperature control dial (12). This heated water is then supplied via a T-section valve, as in the arrangement of FIG. 7A, to the sink and washing chamber simultaneously via water conduits (42) and (41) respectively. A manually operated release valve (103) is located along the water conduit serving the washing chamber and is manually operable by use of a toggle control switch (40) located on the control unit (11), to open and close to release or stop water flowing to the washing chamber and the water outlets within it as desired by the user. The mixer valve, T-section valve, release valve and separate dedicated valves (102) are housed within the control unit (11).

In both examples a shallow P-trap (19) is provided in the waste water outlet serving both the sink (3) and the washing chamber (4). The electric unit of FIG. 7A may be desirable where is no available supply of hot water.

FIG. 12 shows another embodiment of the invention relating to the diagram of FIG. 7B. The control unit in this example is arranged to receive only cold water and houses an electrical water heating apparatus in the manner of FIG. 7A, instead of a mixing valve for mixing received hot and cold water as in FIG. 7B. The control unit (11) includes a control switch (40) connected to a release valve adapted and arranged to control the outflow of water from the control unit (11) selectively to one or the other of the water pipe (42) in fluid communication with the basin tap (20) and the water pipe (41) in fluid communication with the washing unit (4). The control switch may be operable to toggle (e.g. pull up to achieve one switch state, push back down to achieve the other) selectively between these two modes of fluid communication. In the present example, a cold water inlet pipe (43) is arranged to supply cold water to heating elements (not shown) located within the control unit for heating therein to a temperature controlled by the user the second dial control (12) as described above, the water pressure being controlled via the first dial control (13). In this way the temperature, pressure and output location (basin or foot wash unit) may be selectively controlled by the user via the control elements of the control unit. In FIGS. 9 and 12, the foot washing unit is shown with one of its four water outlets removed from the ceiling part of the unit. This is to illustrate the nature of the openings within which the water outlets are removeably housed in the sides of the washing unit. Removal is performed externally of the hollow of the washing unit. A lip circumscribes the innermost rim (44) of the openings in question to abut a periphery of the housed water outlet and prevent its falling into the hollow.

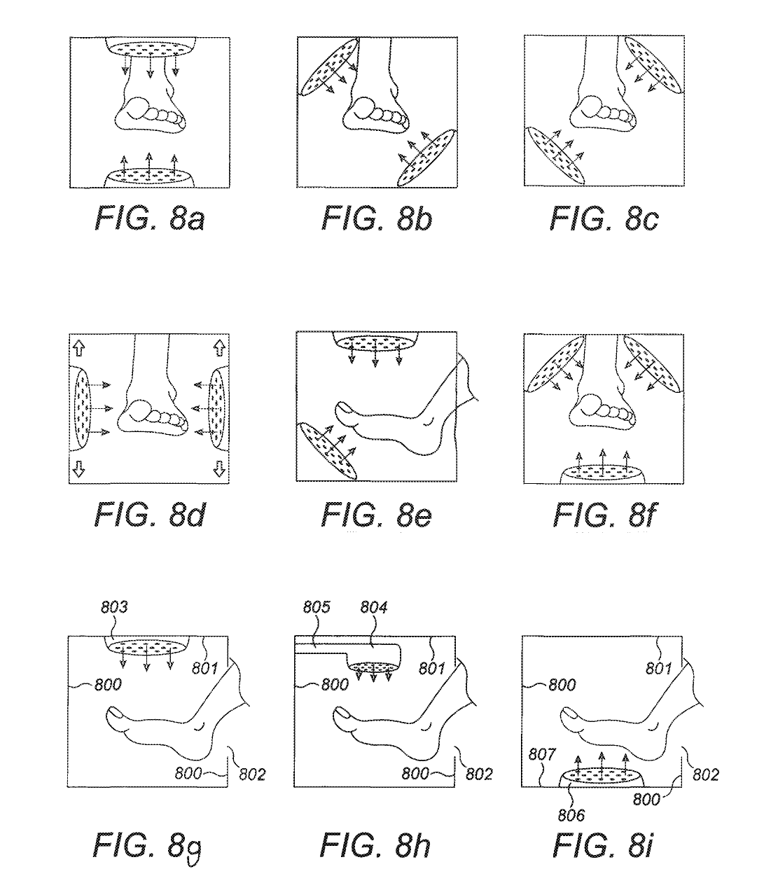

FIGS. 8a to 8f schematically show alternative positions and arrangements of any pair of water outlets of the invention in alternative embodiments which permit different water output directions relative to the foot inserted within the washing chamber.

In FIG. 8a, the washing chamber comprises at least two water outlets arranged in opposition above and below the foot within the hollow of the washing chamber. The water outlets may be attached to the ceiling and floor of the washing chamber to output water vertically upwards and downwards, respectively. The water outlets may directly oppose each other across the hollow of the washing chamber, or may be offset horizontally so as not to directly oppose each other.

In FIG. 8b, the washing chamber comprises at least two water outlets arranged in opposition above and below the foot within the hollow of the washing chamber. A first of the water outlets may be attached to the washing chamber to output water in a direction inclined to the vertical, upwards (obliquely) across the hollow to the lower left side of the inserted foot. Simultaneously, a second of the water outlets may be attached to the washing chamber to output water in a direction inclined to the vertical, downwards (obliquely) across the hollow to the upper right side of the inserted foot. The water outlets may directly oppose each other across the hollow of the washing chamber, or may be offset horizontally so as not to directly oppose each other. The pair of water outlets may alternatively be positioned to direct water to the lower left and upper right sides of the foot as shown in FIG. 8c, in a similar manner.

In FIG. 8d, the washing chamber comprises at least two water outlets arranged at opposite sides of the hollow of the washing chamber for washing opposite sides of the inserted foot. The water outlets are adjustably attached to the side walls (left side and right side, respectively) of the washing chamber to output water horizontally. The vertical height of each water outlet, relative to the floor of the washing chamber, is adjustable to permit the water outlets to be positioned to directly oppose each other across the hollow of the washing chamber, or to vary a vertical offset therebetween, so as not to directly oppose each other. In FIG. 8e, the washing chamber comprises at least two water outlets arranged above and below/ahead of the foot within the hollow of the washing chamber. A first of the water outlets may be attached to the washing chamber to output water in a direction inclined to the vertical, upwards (obliquely) across the hollow to the lower side of the inserted foot at its front. Simultaneously, a second of the water outlets may be attached to the washing chamber to output water in a direction vertically, downwards across the hollow to the upper side of the inserted foot.

In FIG. 8f, the washing chamber comprises a group of three water outlets including two arranged above and at opposite sides, respectively, of the foot and a third below the foot within the hollow of the washing chamber. A first of the water outlets is attached to the washing chamber to output water in a direction inclined to the vertical, downwards (obliquely) across the hollow to the upper left side of the inserted foot. A second of the water outlets is attached to the washing chamber to output water in a direction inclined to the vertical, downwards (obliquely) across the hollow to the upper right side of the inserted foot. Simultaneously, a third of the water outlets may be attached to the washing chamber to output water in a direction vertically upwards (or optionally inclined and upwards) across the hollow to the underside of the inserted foot. The water outlets form a triangular array in this way. FIG. 8g shows a washing chamber with walls (800) and a ceiling (801) defining a covered hollow dimensioned and arranged for receiving a foot of a user via an inlet opening (802) in a wall positioned for admitting the foot into the hollow. The single water outlet (803) of the washing chamber is attached to the ceiling of the washing chamber at a position from which to output water across the hollow of the washing chamber in a direction to intersect the foot of the user when so admitted via the inlet opening. FIG. 8h shows a variant in which the single water outlet (804) of the washing chamber is attached to a wall of the washing chamber via an extended attachment part (805) adjacent the end of which the water outlet is positioned to output water downwardly across the hollow of the washing chamber from a central position in a direction to intersect the foot of the user when so admitted via the inlet opening. FIG. 8i shows a further variant in which the single water outlet (806) of the washing chamber is attached to the floor (807) of the washing chamber to output water upwardly to a foot.

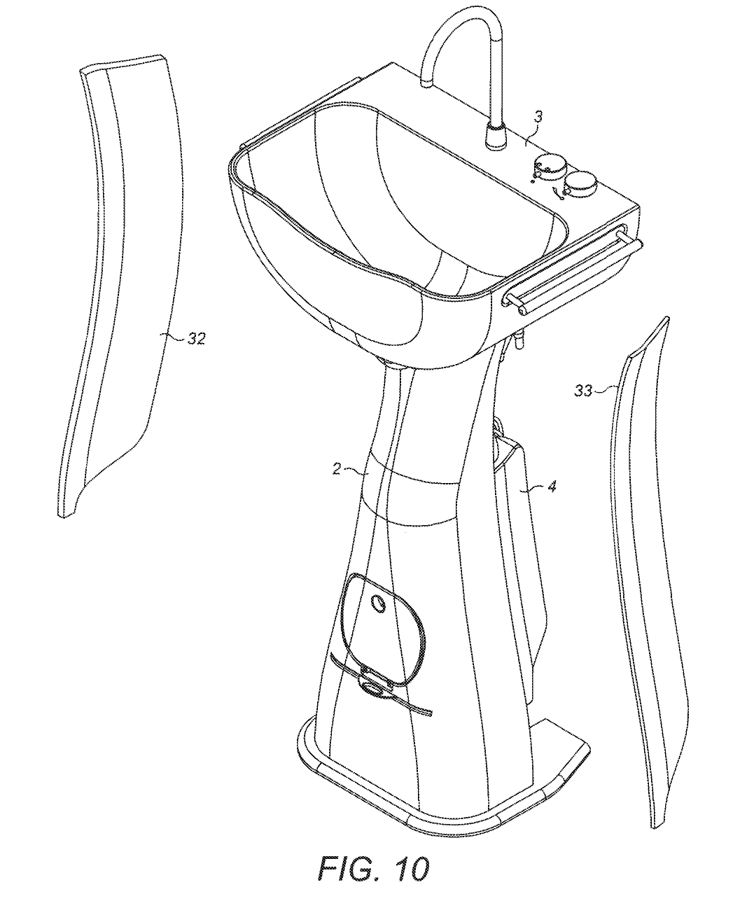

In preferred embodiments of the invention, in any aspect, the pedestal (2) comprises one or more detachable panels enabling access to the foot washing unit when positioned within the pedestal. For example, FIG. 9 shows an example in which the pedestal is provided with a detachable front panel (30) containing the through-opening (3), the door (15) and the grille slot (18) of the pedestal. Detachment of this panel reveals an opening (31) in the pedestal of dimension and shape arranged to permit extraction of the washing unit from the pedestal from the front of the pedestal. Access to the washing unit is also permitted for cleaning/fitting the unit as desired. FIG. 10 shows a further example of an optional detachable panel (32 and/or 33) in the pedestal. One or two (as shown) side panels may be provided in the pedestal panels enabling access to the foot washing unit from one or either side of the pedestal when positioned within the pedestal. Detachment of a panel reveals the washing unit and permits extraction of the washing unit from the pedestal one/either side of the pedestal. Access to the washing unit is also permitted for cleaning/fitting the unit as desired. The/these panels may be detachably fixed to the pedestal via a snap-fit it via attachments such as screws (not shown) or other fasteners of any such suitable type as would be readily apparent to the skilled person.

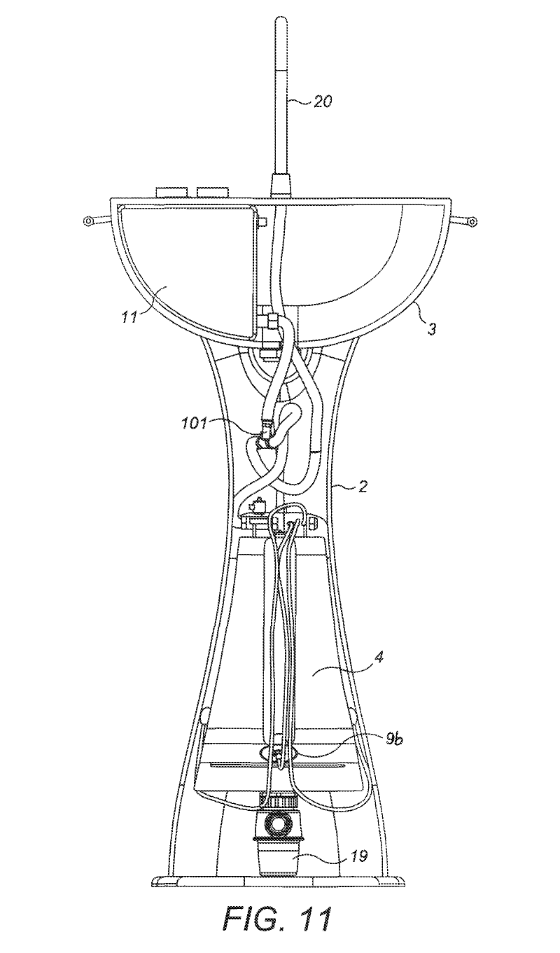

FIG. 11 shows a rear view of the pedestal basin of FIGS. 9 and 10.

### METHOD OF THE INDUSTRIAL APPLICATION OF THE INVENTION

A pedestal wash basin (1) which may be made industrially and applied industrially such as in the housing/hotel construction industry, is provided comprising a basin part (3) upon a pedestal part (2) wherein the pedestal part contains a foot washing apparatus (4) for washing a human foot comprising a washing chamber with walls and a ceiling defining a covered hollow (6) dimensioned and arranged for receiving a foot of a user via an inlet opening (5) in a wall positioned for admitting the foot into the hollow. A water outlet (7, 8) is attached to the washing chamber at a position from which to output water across the hollow of the washing chamber in a direction to intersect the foot of the user when so admitted via the inlet opening. The pedestal part presents a through-opening (3B) in an outwardly-presented surface thereof in register with the hollow of the washing chamber permitting access to the hollow for washing the foot of a user.

1. A pedestal wash basin comprising a basin part upon a pedestal part wherein the pedestal part contains a foot washing apparatus for washing a human foot comprising:
a washing chamber with walls and a ceiling defining a covered hollow dimensioned and arranged for receiving a foot of a user via an inlet opening in a said wall positioned for admitting the foot into the hollow;
a water outlet attached to the washing chamber at a position from which to output water across the hollow of the washing chamber in a direction to intersect the foot of the user when so admitted via said inlet opening;
wherein the pedestal part presents a through-opening in an outwardly-presented surface thereof in register with said hollow of said washing chamber permitting access to said hollow for washing the foot of a user.

2. A pedestal wash basin according to claim 1 in which the water outlet is attached to the ceiling of the washing chamber.

3. A pedestal wash basin according to claim 1 in which the ceiling is inclined relative to said wall containing said inlet opening so as to face in a direction away from the inlet opening.

4. A pedestal wash basin according to claim 1 in which the ceiling and walls of the washing chamber converge so as to meet to form a substantially continuous covering surface in the hollow.

5. A pedestal wash basin according to claim 1 in which the washing chamber comprises opposing said walls spaced by a spacing suitable to admit the width of a foot of the user, and which extend from either side of the inlet opening to meet a back wall positioned opposite the inlet opening and spaced therefrom by a spacing suitable to admit the length of a foot of a user.

6. A pedestal wash basin according to claim 1 comprising a base surface from the edges of which said walls rise to meet said ceiling, wherein the walls surround the base surface on at least three sides and the base surface is adapted to receive water output by the water outlet.

7. A pedestal wash basin according to claim 6 in which the base surface and walls of the washing chamber converge so as to meet to form a substantially continuous boundary in the hollow.

8. A pedestal wash basin comprising a basin part upon a pedestal part wherein the pedestal part contains a foot washing apparatus for washing a human foot comprising:
a washing chamber defining a hollow dimensioned and arranged for receiving the foot of a user;
a first water outlet attached to the washing chamber at a first position to output water in a first direction across the hollow of the washing chamber;
a second water outlet attached to the washing chamber at a second position to output water in a second direction across the hollow of the washing chamber;
wherein the first position and the second position are spaced and arranged so as to admit the foot of a user between the first water outlet and the second water outlet such that the first direction and the second direction simultaneously intersect the foot so admitted
wherein the pedestal part presents a through-opening in an outwardly-presented surface thereof in register with said hollow of said washing chamber permitting access to said hollow for washing the foot of a user.

9. A pedestal wash basin according to claim 8 in which the first water outlet and the second water outlet are positioned respectively at substantially opposite parts of the washing chamber within the hollow thereof.

10. A pedestal wash basin according to claim 8 in which the first direction is substantially opposite to the second direction.

11. A pedestal wash basin according to claim 8 in which the first direction is oblique to the second direction.

12. A pedestal wash basin according to claim 8 in which the first direction and the second direction are generally convergent.

13. A pedestal wash basin according to claim 8 in which one or more of the first water outlet and the second water outlet comprises a plurality of sub-outlets adapted and arranged in an array to output water therefrom as a shower of water.

14. A pedestal wash basin according to claim 8 in which the first water outlet and the second water outlet are positioned respectively at substantially opposite walls of the washing chamber within the hollow thereof to permit the foot of a user to be washed thereby from opposite sides.

15. A pedestal wash basin according to claim 8 in which the first water outlet is positioned at the floor of the washing chamber within the hollow thereof and the second water outlet is positioned at the ceiling of the washing chamber within the hollow thereof to permit the foot of a user to be washed thereby from above and below.

16. A pedestal wash basin according to claim 8 in which the washing chamber comprises an inlet opening permitting access to the hollow and dimensioned to admit the foot of a user.

17. A pedestal wash basin according to claim 8 in which the first water outlet is positioned at the floor of the washing chamber within the hollow thereof and the second water outlet is positioned at the ceiling of the washing chamber within the hollow thereof to permit the foot of a user to be washed thereby from above and below, the washing chamber comprising an inlet opening permitting access to the hollow and dimensioned to admit the foot of a user, and in which at least a part of said floor is inclined towards said inlet opening and at least a part of said ceiling is inclined towards said inclined part of said floor.

18. A pedestal wash basin according to claim 8 including:
a third water outlet attached to the washing chamber at a third position to output water in a third direction across the hollow of the washing chamber;
wherein the first position, the second position and the third position are spaced and arranged so as to admit the foot of a user between the third water outlet and the first water outlet and/or the second water outlet such that the first direction and the second direction and/or the second direction simultaneously intersect the foot so admitted.

19. A pedestal wash basin according to claim 8 further including:
a third water outlet attached to the washing chamber at a third position to output water in a third direction across the hollow of the washing chamber;
a fourth water outlet attached to the washing chamber at a fourth position to output water in a fourth direction across the hollow of the washing chamber;
wherein the third position and the fourth position are spaced and arranged so as to admit the foot of a user between the third water outlet and the fourth water outlet such that the third direction and the fourth direction simultaneously intersect the foot so admitted.

20. A pedestal wash basin according to claim 19 in which:
the first water outlet and the second water outlet are positioned respectively at substantially opposite walls of the washing chamber within the hollow thereof to permit the foot of a user to be washed thereby from opposite sides; and
the third water outlet and is positioned at the floor of the washing chamber within the hollow thereof and the fourth water outlet is positioned at the ceiling of the washing chamber within the hollow thereof to permit the foot of a user to be washed thereby from above and below.

21. A pedestal wash basin according to claim 8 including one or more water conduits for receiving water from a water supply independent of the apparatus and for conducting the received water to said water outlets thereof.

22. (canceled)

23. A pedestal wash basin according to claim 1 in which the foot washing apparatus is detachably attached to said pedestal part.

24. A kit of parts for a pedestal wash basin according to any preceding claim 1
comprising:
said pedestal part;
said basin part adapted to be mounted upon the pedestal part; and
said foot washing apparatus;
wherein the pedestal part presents a through-opening in an outwardly-presented surface thereof and the foot washing apparatus is adapted to be mounted within the pedestal part to place said through-opening in register with said hollow of said washing chamber to permit access to said hollow for washing the foot of a user.
